(19) United States
(12) Patent Application Publication
(10) Pub. No.: US 2014/0205893 A1
(43) Pub. Date: Jul. 24, 2014

(54) CASE FOR PACKING BATTERY

(71) Applicants: SAMSUNG SDI CO., LTD., Yongin-si (KR); ROBERT BOSCH GMBH, Stuttgart (DE)

(72) Inventors: Taisun You, Yongin-si (KR); Yongsam Kim, Yongin-si (KR); Janghyun Song, Yongin-si (KR)

(73) Assignees: ROBERT BOSCH GMBH, Stuttgart (DE); SAMSUNG SDI CO., LTD., Yongin-si (KR)

(21) Appl. No.: 13/801,362

(22) Filed: Mar. 13, 2013

(30) Foreign Application Priority Data
Jan. 23, 2013 (KR) 10-2013-0007524

(51) Int. Cl. H01M 2/02

(52) U.S. Cl. CPC H01M 2/02
USPC 429/176

(57) ABSTRACT

A case for packing a battery including a receiving case in which one or more battery cells are receivable, the receiving case including an open top portion; and a cover covering the open top portion of the receiving case and including a bottom part configured to surround peripheral portions of terminals of the one or more battery cells to insulate the terminals.

### CROSS-REFERENCE TO RELATED APPLICATION

This application claims priority to and the benefit of Korean Patent Application No. 10-2013-0007524, filed on Jan. 23, 2013 in the Korean Intellectual Property Office, the entire content of which is incorporated herein by reference.

### BACKGROUND

1. Field

Aspects of embodiments of the present invention relate to a case for packing a battery.

2. Description of the Related Art

Secondary batteries are rechargeable, unlike primary batteries which are not. Types of secondary batteries include a low-capacity battery including a battery cell in the form of a pack and typically used for small portable electronic devices such as cellular phones and camcorders, and a high-capacity battery including dozens of battery cells connected to one another and typically used as a motor-driving power source, such as for electric scooters, hybrid vehicles, or electric vehicles.

Typically, manufactured secondary batteries are inserted into a packing box, and positive electrode terminals and negative electrode terminals of battery cells are fastened with insulation caps to then be delivered to suppliers. Since it is necessary to separately fasten the respective terminals with insulation caps at a packing stage, there are several problems, including time loss and inconvenience in packing. In addition, if an external shock is applied in the course of transporting a packing box containing battery cells, the battery cells may move within the packing box, resulting in damage to the battery cells.

### SUMMARY

According to an aspect of embodiments of the present invention, a case for packing a battery increases working efficiency in packing battery cells and minimizes or reduces damage to the packed battery cells.

According to one or more embodiments of the present invention, a case for packing a battery includes: a receiving case in which one or more battery cells are receivable, the receiving case including an open top portion; and a cover covering the open top portion of the receiving case and including a bottom part configured to surround peripheral portions of terminals of the one or more battery cells to insulate the terminals.

The receiving case may include a main body, and an individual receiving part including individual receiving spaces configured to receive the battery cells in the main body.

The individual receiving part may include a plurality of partition walls connected to an internal wall of the main body and arranged to receive the battery cells.

The cover may include a cover plate and one or more protrusion parts protruding from a surface of the cover plate, and each of the one or more protrusion parts may have a battery groove into which a top portion of a battery cell of the one or more battery cells is receivable, and a plurality of terminal grooves formed on a bottom surface of the battery groove to receive the terminals of the battery cell therein.

Each of the one or more protrusion parts may include a stepped portion between the battery groove and a terminal groove of the plurality of terminal grooves.

The cover may include a cover plate and one or more protrusion parts protruding from a surface of the cover plate, and each of the one or more protrusion parts may have a plurality of terminal grooves to receive the terminals therein.

The cover may be integrally formed as a single body.

The cover may include polyethylene terephthalate (PET).

The case may further include a polyethylene terephthalate (PET) layer on a surface of the bottom part of the cover.

According to one or more embodiments of the present invention, a case for packing a battery includes: a receiving part receiving a plurality of battery cells, the receiving part including an open top portion; and an insulating cover covering the open top portion of the receiving part and having a plurality of grooves receiving terminals of the battery cells.

According to one or more embodiments of the present invention, a case for packing a battery includes: a receiving part receiving a plurality of battery cells, the receiving part including an open top portion; and an insulating cover covering the open top portion of the receiving part and having a plurality of first grooves receiving top portions of the battery cells received in the receiving part, and a plurality of second grooves receiving terminals of the battery cells.

The receiving part may include a main body, and an individual receiving part including a plurality of partition walls connected to an internal wall of the main body and arranged to receive the battery cells.

A height of a partition wall of the plurality of partition walls may be less than a height of a battery cell of the plurality of battery cells.

An internal surface defining a first groove of the plurality of first grooves may make contact with an upper outer surface of a battery cell of the plurality of battery cells received in the receiving case.

A bottom surface defining a first groove of the plurality of first grooves may make contact with a top surface of a battery cell of the plurality of battery cells received in the receiving case.

Each of the one or more protrusion parts may include a stepped portion between a first groove of the plurality of first grooves and a second groove of the plurality of second grooves.

As described above, according to an aspect of embodiments of the present invention, a case for packing a battery increases working efficiency in packing battery cells while minimizing or reducing damage of the packed battery cells.

### BRIEF DESCRIPTION OF THE DRAWINGS

Features and aspects of the present invention will be more apparent from the following detailed description, in which some exemplary embodiments are described in further detail, in conjunction with the accompanying drawings, in which:

FIG. 1 is a perspective view of a case for packing a battery, according to an embodiment of the present invention;

FIGS. 2A and 2B are exploded perspective views of the battery packing case of FIG. 1;

FIG. 3 is a cross-sectional view of the battery packing case of FIG. 1, taken along the lines I-I′ and I″-I′″ of FIG. 2A;

FIG. 4 is a partial cross-sectional view of the battery packing case of FIG. 1, taken along the lines II-II′ and II″-II′″ of FIG. 2A;

FIGS. 5 and 6 illustrate a packing procedure of battery cells in the battery packing case of FIG. 3;

FIGS. 7 and 8 illustrate a packing procedure of battery cells in the battery packing case of FIG. 4;

FIGS. 9 and 10 are cross-sectional views of a case for packing a battery, according to another embodiment of the present invention; and

FIGS. 11 and 12 illustrate a packing procedure of battery cells in the battery packing case of FIG. 10.

### DETAILED DESCRIPTION

Some exemplary embodiments of the present invention are described more fully hereinafter with reference to the accompanying drawings; however, embodiments of the present invention may be embodied in different forms and should not be construed as limited to the embodiments set forth herein. As those skilled in the art would realize, the described embodiments may be modified in various different ways, all without departing from the spirit or scope of the present invention. Accordingly, the drawings and description are to be regarded as illustrative in nature and not restrictive.

A case for packing a battery according to some exemplary embodiments of the present invention is described in further detail below with reference to the accompanying drawings.

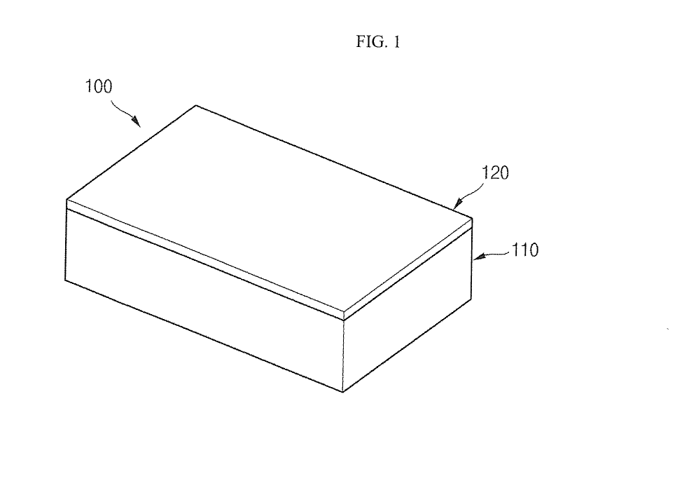

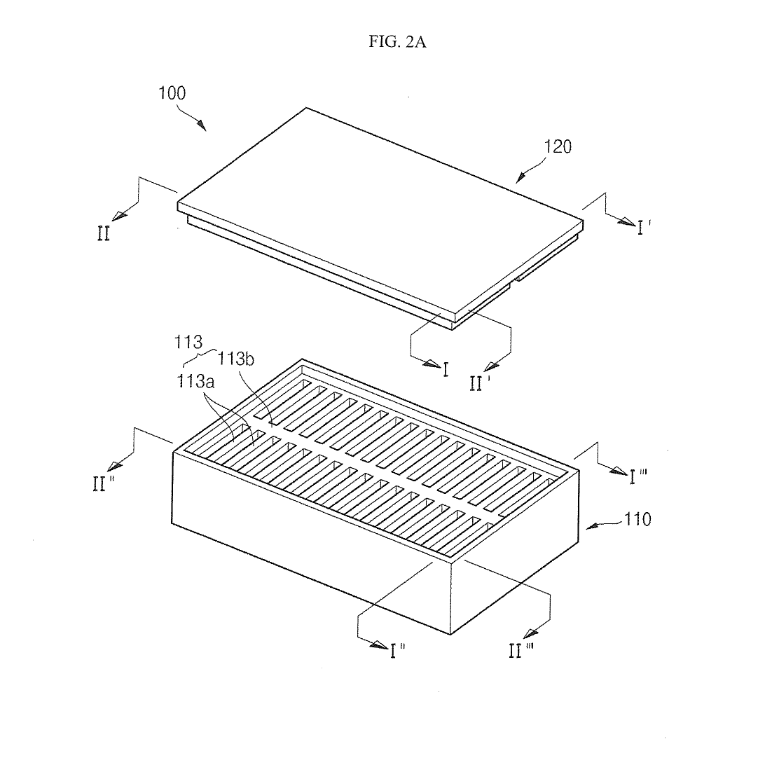

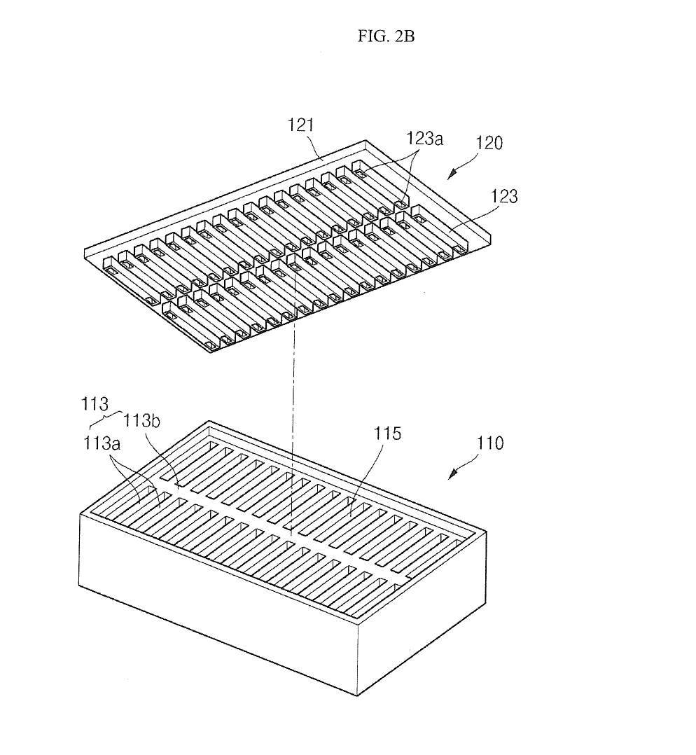

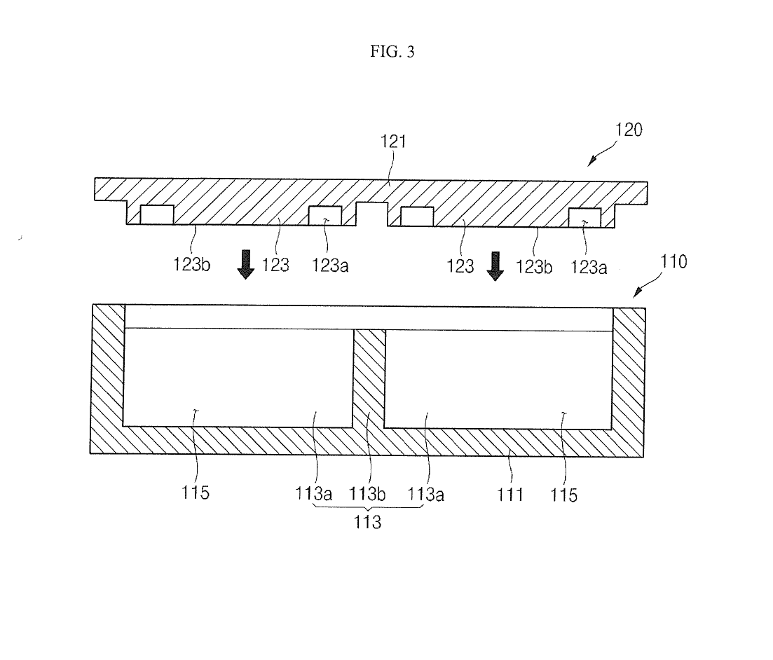

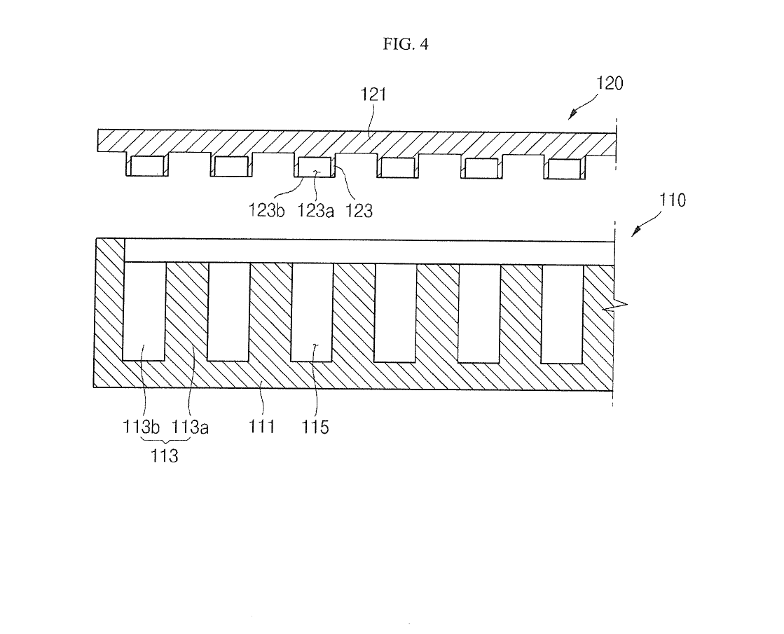

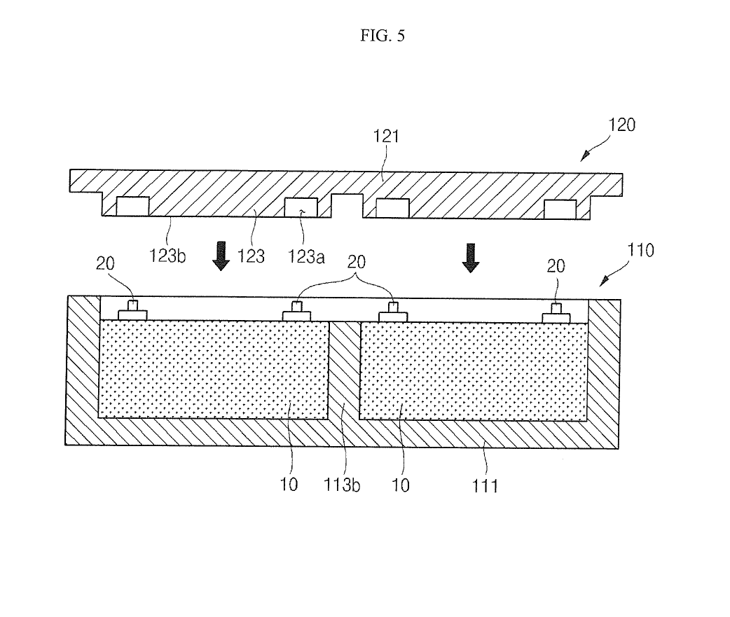

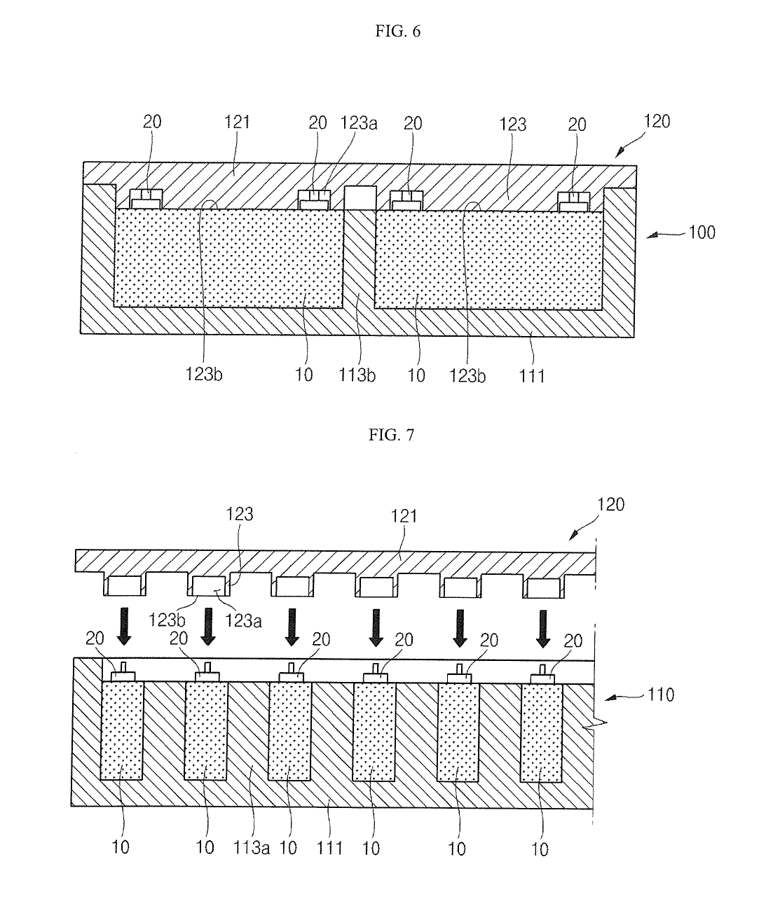

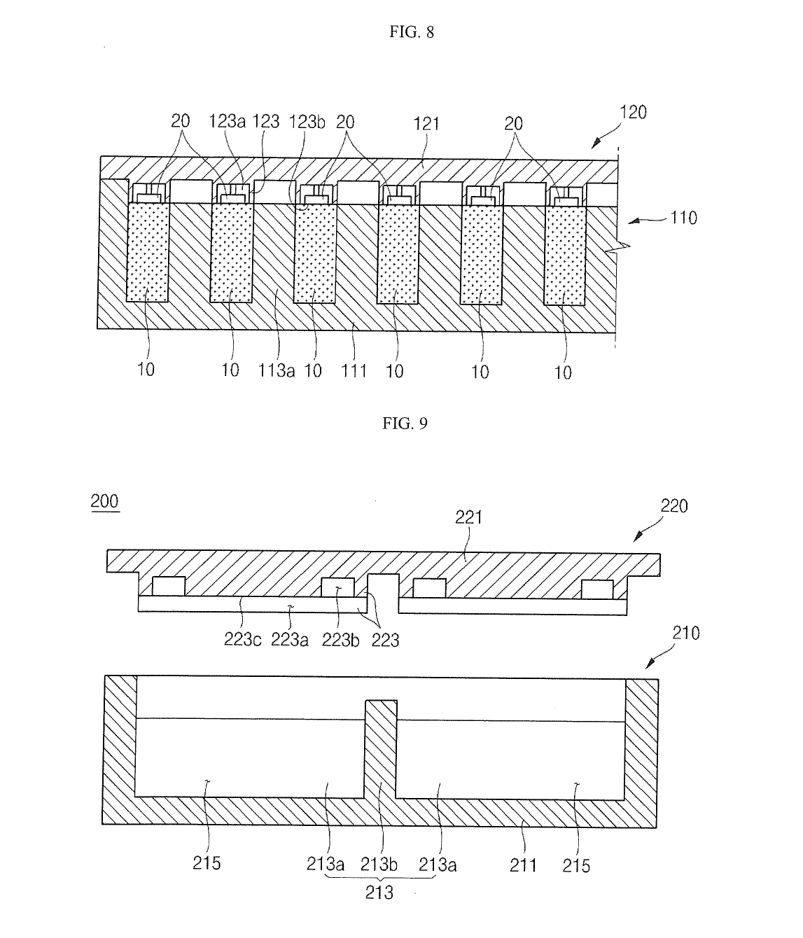

FIG. 1 is a perspective view of a case for packing a battery, according to an embodiment of the present invention; FIGS. 2A and 2B are exploded perspective views of the battery packing case of FIG. 1; FIG. 3 is a cross-sectional view of the battery packing case of FIG. 1, taken along the lines I-I′ and I″-I′″ of FIG. 2A; FIG. 4 is a partial cross-sectional view of the battery packing case of FIG. 1, taken along the lines II-II′ and II″-II′″ of FIG. 2A; FIGS. 5 and 6 illustrate a packing procedure of battery cells in the battery packing case shown in FIG. 3; and FIGS. 7 and 8 illustrate a packing procedure of battery cells in the battery packing case shown in FIG. 4.

Referring to FIGS. 1 to 8, a case 100 for packing a battery, which is also referred to as a battery packing case 100, according to an embodiment of the present invention includes a receiving case 110 and a cover 120.

The receiving case 110 has a rectangular or approximately rectangular box shape and includes an opening at a surface. For purposes of description, the opening will be described as being provided at a top portion of the receiving case 110. The receiving case 110 provides a space for receiving a plurality of battery cells 10. In one embodiment, the receiving case 110 may include a main body 111 and an individual receiving part 113.

The main body 111 may form an exterior portion of the receiving case 110, providing an overall frame of the receiving case 110. The main body 111 may have a bottom part and side walls extending vertically from edges of the bottom part. For example, in one embodiment, the receiving case 110 is shaped as a rectangular parallelepiped, such that the main body 111 has a rectangular bottom part and sidewalls extending vertically from edges of the bottom part.

The individual receiving part 113, in one embodiment, includes a plurality of individual receiving spaces 115 to allow the battery cells 10 to be stably held or fixed in the main body 111. In one embodiment, the individual receiving spaces 115 are spaces in which the battery cells 10 are separated and received in the main body 111, and are configured as grooves allowing the battery cells 10 to be individually received or mounted therein. In order to form the individual receiving spaces 115, the individual receiving part 113 may include a plurality of partition walls 113a and 113b. The plurality of partition walls 113a and 113b may include a plurality of first partition walls 113a, and one or more second partition walls 113b crossing the first partition walls 113a, and may divide the internal space of the main body 111. The first and second partition walls 113a and 113b may be connected to one or more internal walls of the main body 111.

In one embodiment, the first and second partition walls 113a and 113b are arranged to be spaced apart at intervals (e.g., constant intervals) from each other to form the individual receiving spaces 115 sized to allow the battery cells 10 to be inserted and mounted therein. In one embodiment, the individual receiving spaces 115 are formed with the intervals between the first and second partition walls 113a and 113b such that the battery cells 10 and the first and second partition walls 113a and 113b tightly contact each other when the battery cells 10 are inserted in the individual receiving spaces 115.

A height of each of the first and second partition walls 113a and 113b may be smaller than that of each of the battery cells 10. If the height of each of the first and second partition walls 113a and 113b is greater than that of each of the battery cells 10, it may be difficult to separate the battery cells 10 from the receiving case 110.

In one embodiment, the battery cells 10 are inserted into the individual receiving spaces 115 such that terminals 20 of the battery cells 10 face the top portion of the receiving case 110.

However, the present invention does not limit the structure of the receiving case 110 to that illustrated herein. Rather, in other embodiments, the receiving case 110 may have any other configuration or structure suitable to stably fix the battery cells by providing separate spaces to receive multiple battery cells and make close contact with the separately received battery cells.

The cover 120 is configured to cover (e.g., entirely cover) the open top portion of the receiving case 110, and a bottom part of the cover 120 surrounds the terminals 20 of the battery cells 10 received in the receiving case 110, thereby insulating the terminals 20. The cover 120, in one embodiment, may include a cover plate 121 and a plurality of protrusion parts 123.

The cover plate 121 may be sized to cover the open top portion of the receiving case 110. In one embodiment, as described above, the receiving case 110 has a rectangular or approximately rectangular box shape and has one open surface. Thus, the cover plate 121 may also have a rectangular or approximately rectangular shape corresponding to that of the receiving case 110.

The plurality of protrusion parts 123 may protrude from a bottom surface of the cover plate 121 and may each be generally shaped as a rectangular parallelepiped. In one embodiment, when the receiving case 110 is covered by the cover 120, the protrusion parts 123 may be located corresponding to the individual receiving spaces 115. In one embodiment, the protrusion parts 123 may be located corresponding to the individual receiving spaces 115 and may be spaced apart from each other at an interval (e.g., a predetermined interval) on the bottom surface of the cover plate 121.

The plurality of protrusion parts 123 may include a plurality of terminal grooves 123a. The number of terminal grooves 123a of each one of the protrusion parts 123 may be equal to the number of the terminals 20 of each of the battery cells 10, and the terminal grooves 123a may be located corresponding to the terminals 20, respectively. The terminal grooves 123a are formed inwardly to have a depth (e.g., a predetermined depth) from an outer surface 123b of the protrusion part 123. When the receiving case 110 is covered by the cover 120, the terminal grooves 123a may be located corresponding to the terminals 20 of the battery cells 10, respectively. In addition, when the terminals 20 are inserted into the terminal grooves 123a, the terminal grooves 123a may have sizes such that the terminals 20 do not contact internal surfaces of the protrusion parts 123 defining the terminal grooves 123a.

When the cover 120 is closed, the terminals 20 of the battery cells 10 are received in the terminal grooves 123a to then be surrounded by the protrusion parts 123. In addition, when the receiving case 110 is covered by the cover 120, the outer surfaces 123b of the protrusion parts 123 make contact with top surfaces of the battery cells 10, thereby preventing or substantially preventing the battery cells 10 received in the receiving case 110 from moving toward the cover 120. Accordingly, the battery cells 10 can be firmly fixed in the battery packing case 100.

In another embodiment, the protrusion parts 123 may not be provided in plural, and a single protrusion part may be provided. That is, the protrusion parts 123 may not be separately formed on the bottom surface of the cover plate 121 but may be formed instead as a single body. In such a case, the terminal grooves 123a are located corresponding to the terminals 20 of the battery cells 10, and the protrusion parts 123 are not separately formed at locations corresponding to the individual receiving spaces 115.

The cover 120, in one embodiment, may be formed as a single body. The cover 120 may include an insulating material, or an insulating material may be provided on at least a surface of the bottom part of the cover 120. In one embodiment, for example, the cover 120 may be formed of or include polyethylene terephthalate (PET). In another embodiment, for example, a PET layer may be formed on the bottom surface of the cover plate 121 and surfaces of the protrusion parts 123. Here, the surfaces of the protrusion parts 123 may include at least one of the outer surfaces 123b of the protrusion parts 123 or the internal surfaces of the protrusion parts 123 defining the terminal grooves 123a.

A method of packing the battery cells 10 in the battery packing case 100, according to an embodiment of the present invention, is described in further detail below.

First, the battery cells 10 are inserted into the individual receiving spaces 115 of the receiving case 110. When the battery cells 10 are inserted into the individual receiving spaces 115, the terminals 20 are made to face the top portion of the receiving case 110.

Next, the top portion of the receiving case 110 having the battery cells 10 received therein is covered by the cover 120. The receiving case 110 is covered by the cover 120 such that the terminal grooves 123a of the cover 120 correspond to the terminals 20 of the battery cells 10. As the terminals 20 of the battery cells 10 are received in the terminal grooves 123a of the cover 120, they may be surrounded by the protrusion parts 123. As described above, since the protrusion parts 123 or the internal surfaces of the protrusion parts 123 defining the terminal grooves 123a are made of insulating materials, all of the terminals 20 of the battery cells 10 may be insulated by the cover 120 while being covered by the cover 120. As a result, an effect of fastening the terminals 20 of the battery cells 10 concurrently, or simultaneously, with insulation caps can be achieved while sealing the top portion of the receiving case 110.

Conventionally, battery cells are received in packing boxes and then covered with a cover after terminals of the battery cells are individually fastened with insulation caps, thereby packing the battery. By contrast, according to one or more embodiments of the present invention, the effect of fastening the terminals of the battery cells all at once with insulation caps can be achieved easily and efficiently by covering the battery cells with the cover. Accordingly, a time required for packing the battery cells can be reduced, and packing can be simplified.

A case for packing a battery according to another embodiment of the present invention is described below. However, components having a same configuration and function as those described above may be briefly described, and the differences are described in further detail.

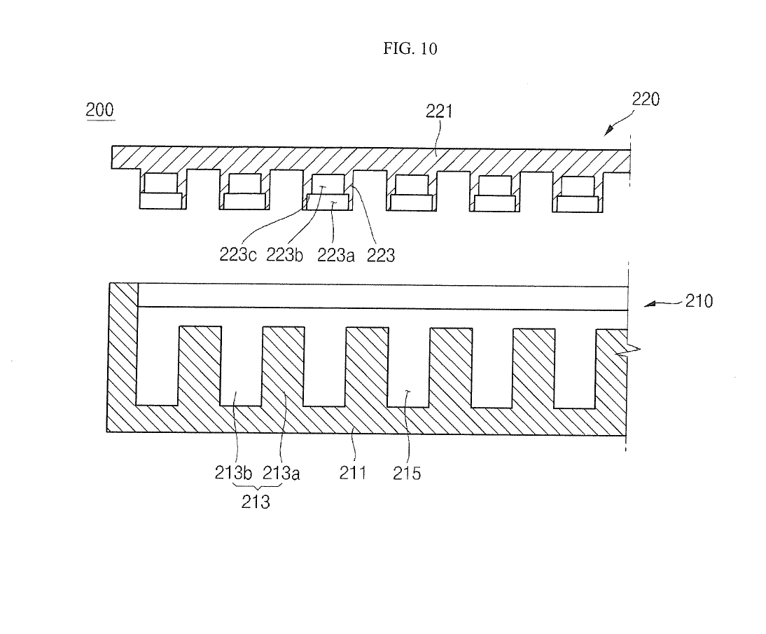

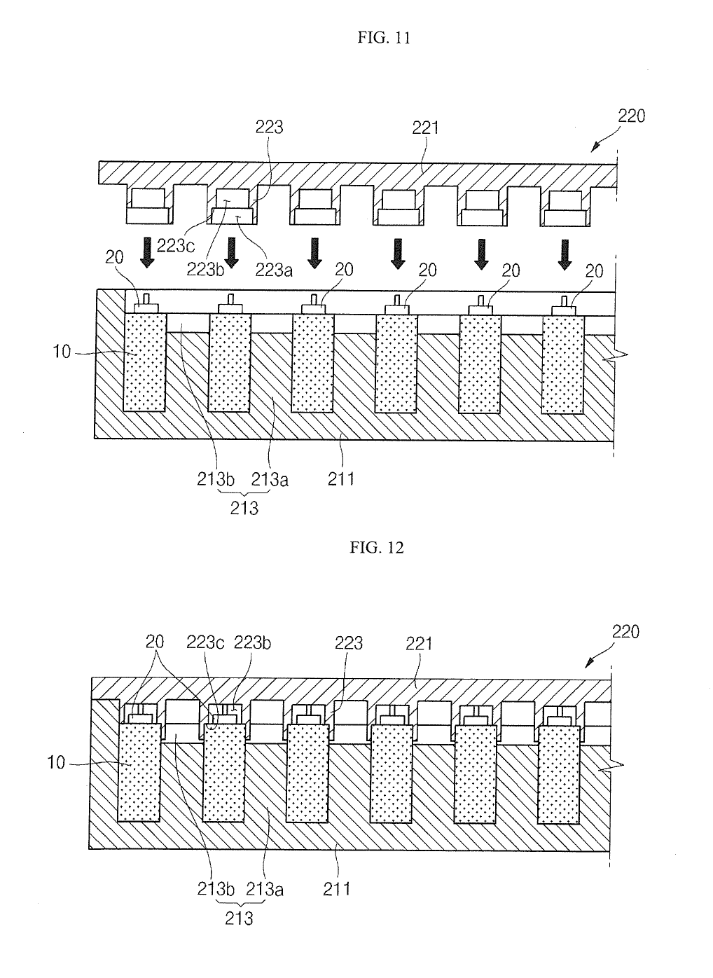

FIGS. 9 and 10 are cross-sectional views of a case for packing a battery according to another embodiment of the present invention, and FIGS. 11 and 12 illustrate a procedure of packing battery cells in the battery packing case shown in FIG. 10. Here, FIG. 9 is a cross-sectional view corresponding to a cross-sectional view taken along the lines I-I′ and I″-I′″ of FIG. 2A; and FIG. 10 is a partial cross-sectional view corresponding to a partial cross-sectional view taken along the lines II-II′ and II″-II′″ of FIG. 2A.

Referring to FIGS. 9 to 12, a battery packing case 200 according to another embodiment of the present invention includes a receiving case 210 and a cover 220.

The receiving case 210 may include a main body 211 and an individual receiving part 213. The individual receiving part 213 may include a plurality of first partition walls 213a and one or more second partition walls 213b, and the first and second partition walls 213a and 213b may form a plurality of individual receiving spaces 215.

The receiving case 210 and the receiving case 110 described above are different from each other in view of a height of the first partition wall 213a. In the receiving case 110 described above, the first partition wall 113a has a same or substantially same height as the battery cell 10. However, in the receiving case 210, the first partition wall 213a has a smaller height than the battery cell 10. In this case, the battery cells 10 can be more easily separated from the receiving case 210.

The cover 220, in one embodiment, may include a cover plate 221 and a plurality of protrusion parts 223.

The cover plate 221 may have a same or substantially same configuration as the cover plate 121 described above.

The plurality of protrusion parts 223 may protrude from a bottom surface of the cover plate 221 and may be shaped as a rectangular or substantially rectangular parallelepiped. When the receiving case 210 is covered by the cover 220, the protrusion parts 223 may be located corresponding to individual receiving spaces 215. In one embodiment, the protrusion parts 223 may be located corresponding to the individual receiving spaces 215 and may be formed on a bottom surface of the cover plate 221 to be spaced apart from each other at an interval (e.g., a predetermined interval).

Each of the plurality of protrusion parts 223 may include a battery groove 223a and a terminal groove 223b. The battery groove 223a corresponds to each of the battery cells 10, and the top portion of each of the battery cells 10 may be inserted into the battery groove 223a. The terminal groove 223b corresponds to each of the terminals 20 of the battery cells 10, and each of the terminals 20 of the battery cells 10, inserted into the battery groove 223a, may be inserted into the terminal groove 223b.

When compared with the protrusion parts 123 of the cover 120 described above, each of the protrusion parts 223 of the cover 220 further includes the battery groove 223a into which the top portion of each of the battery cells 10 is inserted. The battery groove 223a, in one embodiment, may have a constant depth from an outer surface of the protrusion part 223 and a width (e.g., a predetermined width), and may have a size to allow a part of the top portion of each of the battery cells 10 to be inserted when the receiving case 210 is covered by the cover 220.

In one embodiment, when the top portion of each of the battery cells 10 is inserted into the battery groove 223a, a bottom surface 223c of the battery groove 223a makes contact with a top surface of each of the battery cells 10 while an internal surface (e.g., a vertical surface) of the protrusion part 223 defining the battery groove 223a makes contact with an upper outer surface of each of the battery cells 10. As described above, since the bottom surface 223c of the battery groove 223a makes contact with a top surface of each of the battery cells 10, it is possible to prevent or substantially prevent the battery cells 10 received in the receiving case 210 from moving toward the cover 220. At the same time, since the internal surface of the protrusion part 223 defining the battery groove 223a makes contact with an upper outer surface of each of the battery cells 10, it is possible to prevent or substantially prevent the top portions of the battery cells 10 from moving toward the first and second partition walls 223a and 223b. Since bottom portions of the battery cells 10, excluding the top portions of the battery cells 10, are inserted into the individual receiving spaces 215, the first and second partition walls 223a and 223b may prevent or substantially prevent the bottom portions of the battery cells 10 from moving. In addition, since the bottom surface 223c of the battery groove 223a makes contact with the top surface of each of the battery cells 10, it is possible to prevent or substantially prevent the battery cells 10 from moving toward the cover 210.

The terminal groove 223b, in one embodiment, may have a constant depth from the bottom surface 223c of the battery groove 223a and a width (e.g., a predetermined width). In one embodiment, the width of the terminal groove 223b may be smaller than that of the battery groove 223a. Accordingly, a stepped portion may be formed at a boundary between the battery groove 223a and the terminal groove 223b. The stepped portion may be part of the bottom surface 223c of the battery groove 223a. Therefore, when the receiving case 210 is covered by the cover 220, the stepped portion between the battery groove 223a and the terminal groove 223b makes contact with the top surface of each of the battery cells 10, thereby preventing or substantially preventing the battery cells 10 from moving toward the cover 210.

In one embodiment, a number of the terminal grooves 223b may be the same as a number of the terminals 20 formed in one of the battery cells 10 and may be located corresponding to the terminals 20. The terminal groove 223b, in one embodiment, may be the same or substantially the same as the terminal groove 123a of the cover 120 described above, and further description of the terminal groove 223b will therefore not be provided herein.

Like the protrusion parts 123 of the cover 120 described above, the protrusion parts 223 of the cover 220, in one embodiment, may not necessarily be provided in plurality, and a single protrusion part may instead be provided. That is, the protrusion parts 223 may not be separately formed on the bottom surface of the cover plate 221 but may be formed instead as a single body, and may not necessarily be separately formed at locations corresponding to the individual receiving spaces 215 as long as the battery grooves 223a are located corresponding to the battery cells 10 and the terminal grooves 223b are located corresponding to the terminals 20 of the battery cells 10.

As described above, when compared with the protrusion parts 123 of the cover 120, the protrusion parts 223 of the cover 220 further include the battery groove 223a. The protrusion parts 223 may therefore be made to protrude from the bottom surface of the cover plate 221 longer than the protrusion parts 123 of the cover 120. Since the protrusion parts 223 protrude longer than the protrusion parts 123, they may protrude to a same depth as the battery groove 223a. Therefore, a height of the first partition wall 213a may be the same as a depth of the battery groove 223a, and may be smaller than that of the partition wall 113a.

Due to this configuration, in the battery packing case 200 according to one embodiment, the battery cells 10 inserted into the receiving case 210 can be more easily separated from the receiving case 210 due to the first partition wall 213a having a smaller height than the battery cells 10. In addition, the battery groove 223a of the cover 220 may prevent or substantially prevent the battery cells 10 from moving more efficiently, thereby minimizing or reducing damage of the battery cells 10.

While some exemplary embodiments of a secondary battery have been described herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present disclosure as set forth in the following claims and equivalents thereof.

What is claimed is:

1. A case for packing a battery, the case comprising:
a receiving case in which one or more battery cells are receivable, the receiving case including an open top portion; and
a cover covering the open top portion of the receiving case and comprising a bottom part configured to surround peripheral portions of terminals of the one or more battery cells to insulate the terminals.

2. The case as claimed in claim 1, wherein the receiving case includes a main body, and an individual receiving part including individual receiving spaces configured to receive the battery cells in the main body.

3. The case as claimed in claim 2, wherein the individual receiving part includes a plurality of partition walls connected to an internal wall of the main body and arranged to receive the battery cells.

4. The case as claimed in claim 1,
wherein the cover comprises a cover plate and one or more protrusion parts protruding from a surface of the cover plate, and
wherein each of the one or more protrusion parts has a battery groove into which a top portion of a battery cell of the one or more battery cells is receivable, and a plurality of terminal grooves formed on a bottom surface of the battery groove to receive the terminals of the battery cell therein.

5. The case as claimed in claim 4, wherein each of the one or more protrusion parts comprises a stepped portion between the battery groove and a terminal groove of the plurality of terminal grooves.

6. The case as claimed in claim 1,
wherein the cover comprises a cover plate and one or more protrusion parts protruding from a surface of the cover plate, and
wherein each of the one or more protrusion parts has a plurality of terminal grooves to receive the terminals therein.

7. The case as claimed in claim 1, wherein the cover is integrally formed as a single body.

8. The case as claimed in claim 1, wherein the cover comprises polyethylene terephthalate (PET).

9. The case as claimed in claim 1, further comprising a polyethylene terephthalate (PET) layer on a surface of the bottom part of the cover.

10. A case for packing a battery, the case comprising:
a receiving part receiving a plurality of battery cells, the receiving part including an open top portion; and
an insulating cover covering the open top portion of the receiving part and having a plurality of grooves receiving terminals of the battery cells.

11. A case for packing a battery, the case comprising:
a receiving part receiving a plurality of battery cells, the receiving part including an open top portion; and
an insulating cover covering the open top portion of the receiving part and having a plurality of first grooves receiving top portions of the battery cells received in the receiving part, and a plurality of second grooves receiving terminals of the battery cells.

12. The case as claimed in claim 11, wherein the receiving part comprises a main body, and an individual receiving part including a plurality of partition walls connected to an internal wall of the main body and arranged to receive the battery cells.

13. The case as claimed in claim 12, wherein a height of a partition wall of the plurality of partition walls is less than a height of a battery cell of the plurality of battery cells.

14. The case as claimed in claim 11, wherein an internal surface defining a first groove of the plurality of first grooves makes contact with an upper outer surface of a battery cell of the plurality of battery cells received in the receiving case.

15. The case as claimed in claim 11, wherein a bottom surface defining a first groove of the plurality of first grooves makes contact with a top surface of a battery cell of the plurality of battery cells received in the receiving case.

16. The case as claimed in claim 11, wherein each of the one or more protrusion parts comprises a stepped portion between a first groove of the plurality of first grooves and a second groove of the plurality of second grooves.
